(19) United States
(12) Patent Application Publication
(10) Pub. No.: US 2020/0074438 A1
(43) Pub. Date: Mar. 5, 2020

(54) MOBILE DEVICE PAYMENT SYSTEM AND METHOD

(71) Applicant: ANDREW A. BOEMI, BARRINGTON, IL (US)

(72) Inventor: ANDREW A. BOEMI, BARRINGTON, IL (US)

(21) Appl. No.: 16/239,079

(22) Filed: Jan. 3, 2019

Related U.S. Application Data
(60) Provisional application No. 62/724,390, filed on Aug. 29, 2018.

(51) Int. Cl. G06Q 20/32; G06Q 20/12; G06Q 20/24; G06Q 40/02; G06Q 20/38; G06Q 20/06; G06Q 20/20

(52) U.S. Cl. CPC G06Q 20/3223; G06Q 20/12; G06Q 20/24; G06Q 40/025; G06Q 20/3276; G06Q 20/3829; G06Q 20/065; G06Q 20/201; G06Q 2220/00; G06Q 20/389

(57) ABSTRACT

A mobile device payment system and method, the method for a mobile device user to purchase goods/services from a merchant with a mobile device including: providing a mobile device; establishing a user account at a first bank; establishing a merchant account at a second bank; receiving a credit request from the mobile device user; converting the requested credit amount to a credit equivalent amount in cyberscrip at the first bank; broadcasting a credit transaction message to a blockchain network; identifying goods/services for purchase; determining a total price for the identified goods/services on the mobile device; acquiring the merchant name for the merchant on the mobile device; actuating a purchase button on the mobile device; converting the total price to a purchase equivalent amount in the cyberscrip; and broadcasting a purchase transaction message to the blockchain network.

### CROSS-REFERENCE TO RELATED APPLICATIONS

This application claims the benefit of U.S. Provisional Patent Application Ser. No. 62/724,390, filed Aug. 29, 2018, incorporated by reference in its entirety herein.

### TECHNICAL FIELD

The technical field of this disclosure is payment systems and methods for electronic commerce, particularly, mobile device payment systems and methods.

### BACKGROUND OF THE INVENTION

Although purchasing goods and services online using a mobile device has become increasingly common, barriers to efficient and cost-effective online purchasing remain. There are a wide variety of payment systems and platforms, e.g., PayPal, available for mobile devices to make payments, but virtually all are tied to processing by third-party credit card or debit card companies (e.g., Visa, CitiBank, etc.) in conjunction with these purchases. Such third-party credit card or debit card companies extract a fee for processing the payment, averaging 20% or more of the payment amount. These fees significantly impact smaller businesses. The payment processing fee is normally paid by the merchants themselves who pass at least a portion of the fee through to consumers in pricing of goods and services. Unfortunately, the third-party payment processing increases costs to the consumers.

Another problem with presently available payment systems is transaction verification and security. Sensitive personal and financial information, such as names, card numbers, and passwords, are exposed every time a consumer makes a purchase. Thieves steal credit/debit card information from poorly secured corporate locations. Actual thefts and the risk of financial liability increase the cost of web commerce to consumers and merchants and discourage consumers from purchasing online.

It would be desirable to have mobile device payment systems and methods that would overcome the above disadvantages.

### SUMMARY OF THE INVENTION

The mobile device payment systems and methods described herein provide for making verified and secure purchases using a mobile device.

One aspect of the invention provides a method for a mobile device user to purchase goods/services from a merchant with a mobile device, the method including: providing a mobile device, the mobile device having a device identifier permanently embedded in the mobile device; receiving a user account request for a user account at a first bank, the user account request including a device name associated with the device identifier, establishing the user account at the first bank, the user account associating the mobile device user with the device name; receiving a merchant account request for a merchant account at a second bank, the merchant account request including a merchant name; establishing the merchant account at the second bank, the merchant account associating the merchant with the merchant name; receiving a credit request from the mobile device user at the first bank, the credit request including a requested credit amount in a government backed currency and the device name; converting the requested credit amount to a credit equivalent amount in cyberscrip at the first bank; broadcasting a credit transaction message to a blockchain network to register transfer in a distributed blockchain of the credit equivalent amount from the first bank to the user account of the mobile device user, the credit transaction message including a first bank parent blockchain reference, the credit equivalent amount, and the device name; identifying goods/services for purchase from the merchant by the mobile device user on the mobile device; determining a total price for the identified goods/services on the mobile device; acquiring the merchant name for the merchant on the mobile device; actuating a purchase button on the mobile device; converting the total price to a purchase equivalent amount in the cyberscrip; and broadcasting a purchase transaction message to the blockchain network to register transfer in the distributed blockchain of the purchase equivalent amount from the user account of the mobile device user to the second bank, the purchase transaction message including a user parent blockchain reference, the purchase equivalent amount, and the merchant name.

Another aspect of the invention provides a method for a mobile device user to purchase goods/services from a merchant in association with a payment system operator, the method including: providing a mobile device to the mobile device user, the mobile device including a consumer account and a universal merchant account, the mobile device having a permanent identifier embedded in the mobile device; establishing a user account for the mobile device user with the payment system operator, the user account associating the mobile device user with the permanent identifier, establishing a merchant account for the merchant with the payment system operator, the merchant account including a merchant identifier and merchant bank deposit information for the merchant; requesting the payment system operator to load consumer credit into the consumer account by providing a credit amount and the permanent identifier to the payment system operator; loading the credit amount into the consumer account of the mobile device associated with the permanent identifier; identifying goods/services for purchase from the merchant by the mobile device user on the mobile device; determining a total price for the identified goods/services on the mobile device; acquiring the merchant account for the merchant on the mobile device; storing the merchant account in the universal merchant account of the mobile device; actuating a purchase button on the mobile device; retrieving merchant bank deposit instructions for the merchant identifier from the universal merchant account in response to the actuating the purchase button; retrieving purchase credit in an amount of the total price from the consumer account in response to the actuating the purchase button; and routing the retrieved credit to the merchant in accordance with the retrieved merchant bank deposit instructions.

Another aspect of the invention provides a method for a mobile device user to purchase goods/services from a merchant in association with a payment system operator, the method including: providing a mobile device including a consumer account to the mobile device user, the mobile device having a device private key permanently embedded in the mobile device; receiving a user account request for a user account at the payment system operator, the user account request being digitally signed with the device private key and including a device public key, the user account associating the mobile device user with the device public key; establishing the user account, the user account associating the mobile device user with the device public key; receiving a merchant account request for a merchant account at the payment system operator, the merchant account request being digitally signed with a merchant private key, the merchant account associating the merchant with a merchant public key; establishing the merchant account, the merchant account associating the merchant with a merchant public key; sending merchant data from the payment system operator to the mobile device user, the merchant data being digitally signed with an operator private key and including the merchant public key; receiving a cryptocurrency request from the mobile device user at the payment system operator, the cryptocurrency request being digitally signed with the device private key, the cryptocurrency request including a requested credit amount and the device public key; sending a cryptocurrency response including the requested credit amount to the mobile device user, the cryptocurrency response being digitally signed with the operator private key; broadcasting a credit transaction message to a blockchain network to register transfer in a distributed blockchain of the requested credit amount from the payment system operator to the mobile device user, the credit transaction message being digitally signed with the operator private key, the credit transaction message including an operator blockchain reference, the requested credit amount, and the device public key; identifying goods/services for purchase from the merchant by the mobile device user on the mobile device; determining a total price for the identified goods/services and the merchant public key on the mobile device; actuating a purchase button on the mobile device; and broadcasting a purchase transaction message to the blockchain network in response to the actuating the purchase button to register transfer in the distributed blockchain of the total price from the mobile device user to the merchant, the purchase transaction message being digitally signed with double-click the device private key, the credit transaction message including a device blockchain reference, the total price, and the merchant public key.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 11 is a schematic diagram of communication architecture for a mobile device payment system in accordance with the invention.

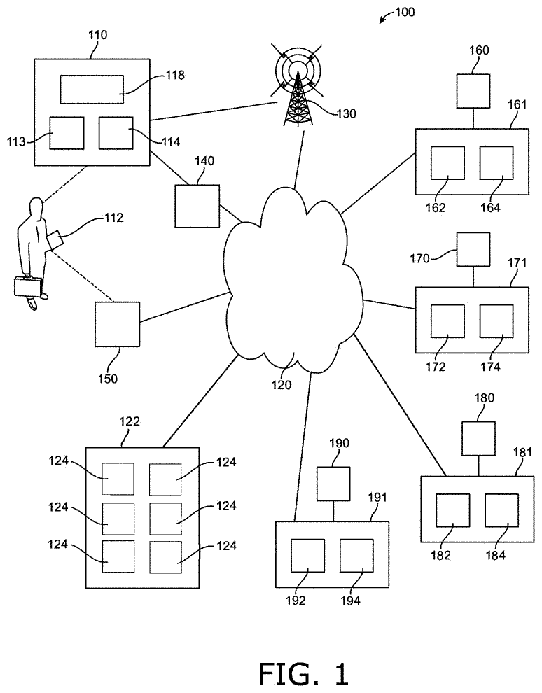

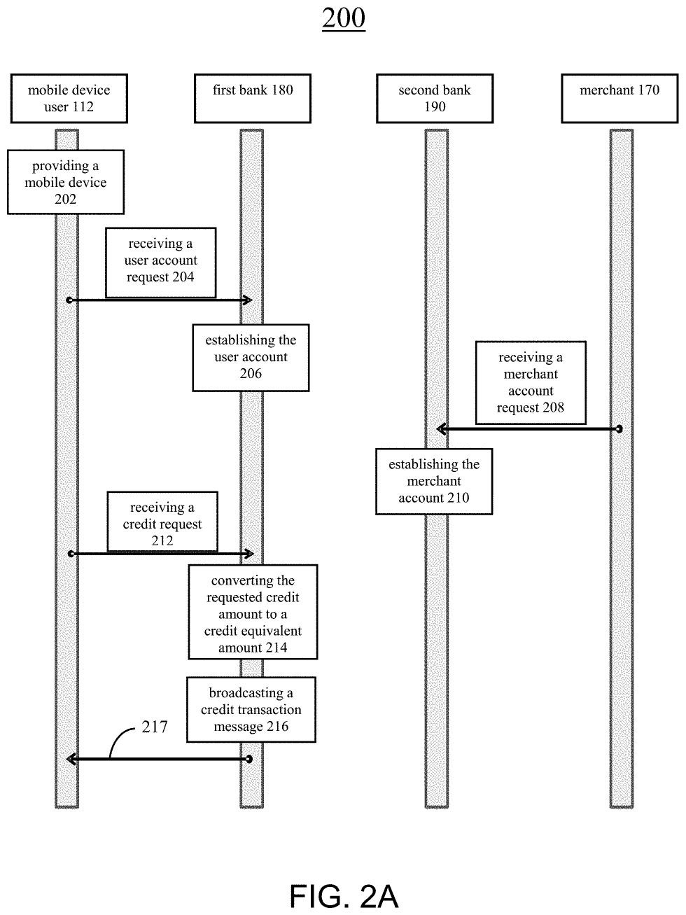

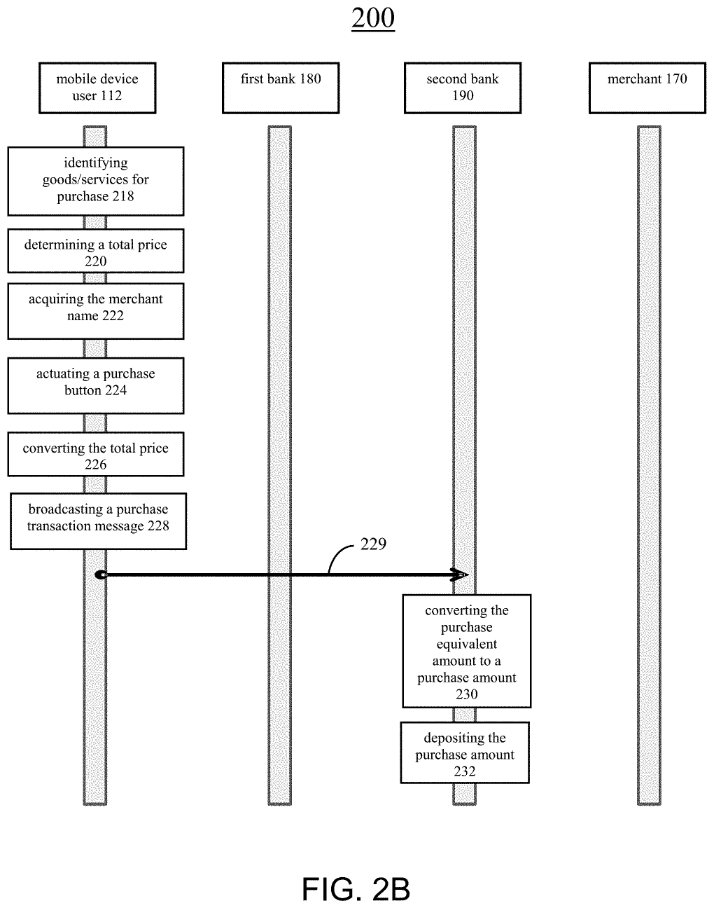

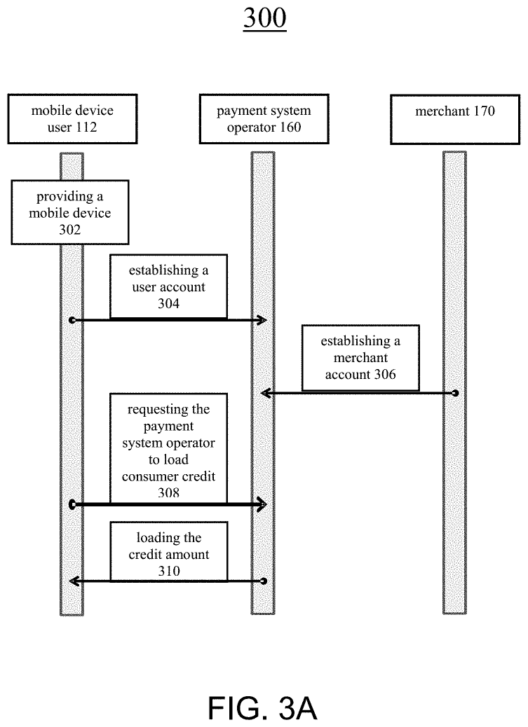

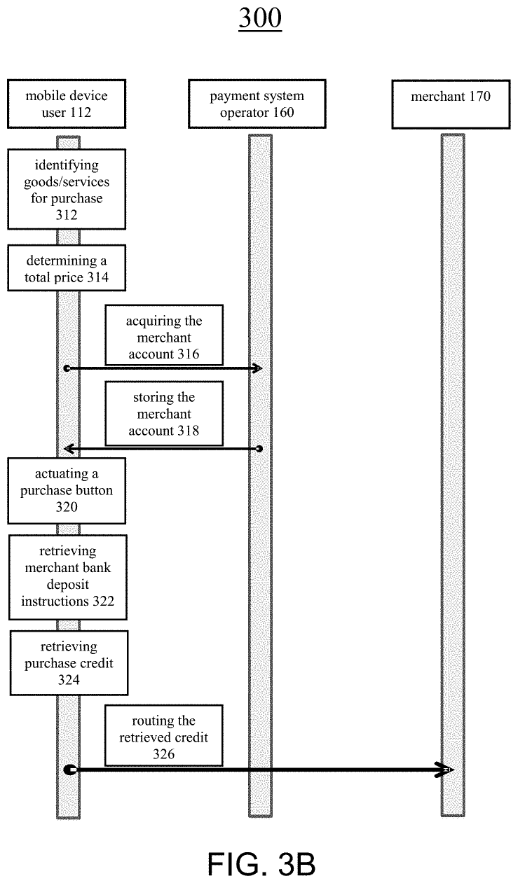

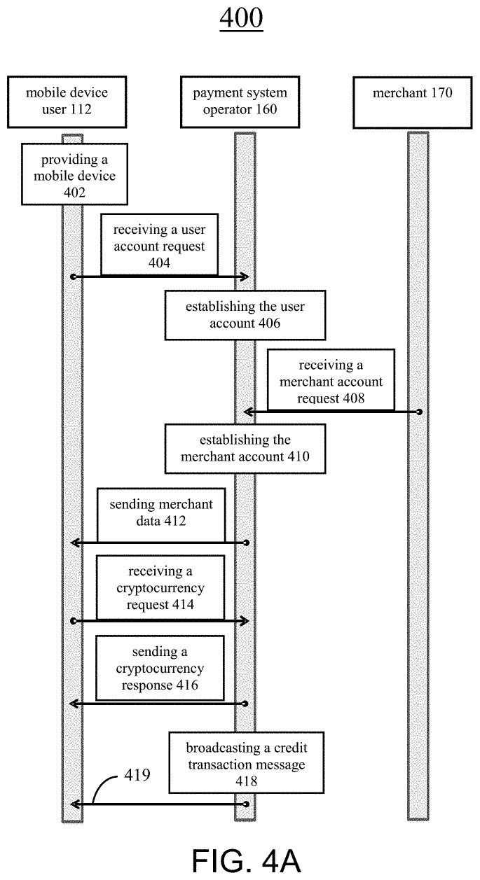

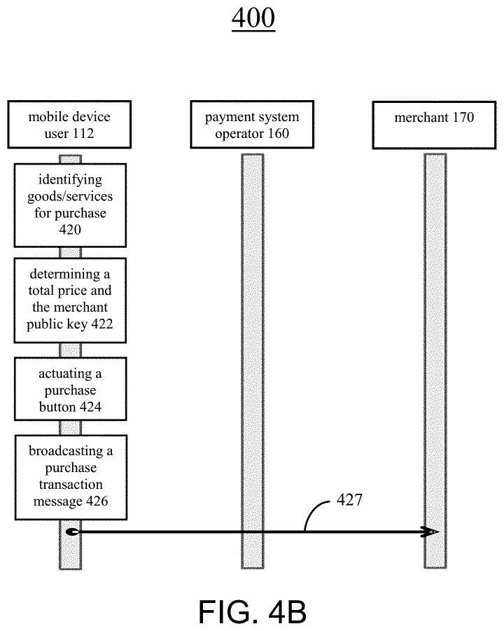

FIGS. 2A & 2B are a block diagram of one embodiment of a mobile device payment method in accordance with the invention.

FIGS. 3A & 3B are a block diagram of another embodiment of a mobile device payment method in accordance with the invention.

FIGS. 4A & 4B are a block diagram of another embodiment of a mobile device payment method in accordance with the invention.

### DETAILED DESCRIPTION

FIG. 1 is a schematic diagram of a mobile device payment system with communication architecture in accordance with the invention. The mobile device payment system allows a mobile device user to purchase goods/services from a merchant with a mobile device.

In various embodiments, the mobile device payment system 100 includes a mobile device 110, a payment system operator server 161, a merchant server 171, a bank one server 181, a bank two server 191, and a distributed blockchain network 122. Each of the mobile device 110, the servers 161, 171, 181, 191, and the distributed blockchain network 122 are operable to communicate with each other. In one example, communications between components can be encrypted as desired for a particular application, e.g., using public and private keys in public-key cryptography. The mobile device 110, merchant server 171, payment system operator server 161, bank one server 181, bank two server 191, distributed blockchain network 122, and optional personal computer 150 include hardware and software as required to connect to the Internet 120. In one example, the operation of the mobile device payment system 100 over the Internet 120 can be cloud computing in which the various components of the mobile device payment system 100 store and access data and programs with each other remotely over the Internet 120.

The mobile device 110 is defined herein as a smart phone, digital tablet, or any other portable wireless mobile device allowing a mobile device user 112 to communicate with the servers 161, 171, 181, 191, and the distributed blockchain network 122. The mobile device 110 is operable to connect the user 112 to the Internet 120 through a cellular system 130 or a wireless node 140, such as a Wi-Fi node, Bluetooth node, or the like. The mobile device 110 can be provided to the mobile device user 112 by another party, such as the payment system operator 160, or a mobile device manufacturer, mobile device supplier, mobile device distributor, mobile phone network provider, a third party, or the like. The mobile device user 112 can optionally connect to the Internet 120 with a personal computer 150 that can optionally be used as part of establishing a user account for the mobile device user, such as confirming details of the user account, confirming that the user account has been established, or the like.

The mobile device 110 has a permanent identifier 118 embedded in the mobile device 110. The mobile device 110 also has a device processor 113 and device memory 114 operably connected to the device processor 114. The mobile device 110 can also include a graphic user interface (not shown) for input and output of information. The mobile device 110 can include other systems useful to particular embodiments of the mobile device payment method, such as a Global Positioning System (GPS) or other locating system operable to determine the location of the mobile device 110 and thus a merchant location in which the mobile device 110 is being used. The mobile device 110 can include a purchase button. In one embodiment, the purchase button can be an icon displayed on a screen of the mobile device. In one embodiment, the purchase button can be a physical button on the mobile device.

The servers 161, 171, 181, 191 can be hardware and/or software servers, and can be single hardware devices or can be a number of distributed hardware devices as desired for a particular application. The servers 161, 171, 181, 191 can also include communication hardware/software as required to carry out the mobile device payment method. Each server is operable to connect its related party to the Internet. and has a processor with a memory operably connected to the processor: the payment system operator server 161 is operable to connect a payment system operator 160 to the Internet 120, and has an operator processor 162 with an operator memory 164 operably connected to the operator processor 162; the merchant server 171 is operable to connect the merchant 170 to the Internet 120, and has a merchant processor 172 with a merchant memory 174 operably connected to the merchant processor 172; the merchant server 171 is operable to connect the merchant 170 to the Internet 120, and has a merchant processor 172 with a merchant memory 174 operably connected to the merchant processor 172; the bank one server 181 is operable to connect the bank one 180 to the Internet 120, and has a bank one processor 182 with a bank one memory 184 operably connected to the bank one processor 182; and the bank two server 191 is operable to connect the bank two 190 to the Internet 120, and has a bank two processor 192 with a bank two memory 194 operably connected to the bank two processor 192.

The distributed blockchain network 122 maintains a distributed blockchain to register transfer of credit or payments from one party to another in the distributed blockchain, which is immutable and maintained in sync by consensus. The distributed blockchain network 122 includes a number of independent, distributed blockchain servers 124, which can be connected to each other over interconnected computer networks, such as the Internet. In one embodiment, the distributed blockchain network 122 is a public network as defined hereby, such as used for the Bitcoin cryptocurrency system, in which independently owned servers operating over a public network maintain the blockchain. In another embodiment, the distributed blockchain network 122 is a private network as defined hereby, such as the IBM Blockchain Platform™ operating over the IBM Cloud (available from IBM Corporation of Armonk, N.Y.), in which privately owned servers operating over a private network maintain the blockchain.

In the embodiment described in association with FIGS. 2A & 2B below, the payment system 100 involves the mobile device user 112, the merchant 170, the first bank 180, and the second bank 190. The mobile device user 112 sets up a user account at the first bank 180 and the merchant 170 sets up a merchant account at the second bank 190. Credits and payments are transferred with cyberscrip through distributed blockchain network 122.

In the embodiment described in association with FIGS. 3A & 3B below, the payment system 100 involves the mobile device user 112, the payment system operator 160, and the merchant 170. The merchant account for the merchant 170 is acquired on the mobile device 110 at the time of purchase at the merchant location. The payment system operator 160 coordinates the payment system 100.

In the embodiment described in association with FIGS. 4A & 4B below, the payment system 100 involves the mobile device user 112, the payment system operator 160, and the merchant 170. The payment system 100 applies public and private keys in public-key cryptography to provide verification and security. Credits and payments are transferred with cyberscrip through distributed blockchain network 122. The payment system operator 160 coordinates the payment system 100.

Those skilled in the art will appreciate that the mobile device payment system 100 can be used to carry out mobile device payment methods such as those discussed in association with FIGS. 2-4 below. The memory of the particular device stores programming code executable by the processor of the particular device to carry out portions of the method performed by the particular device. Referring to FIG. 1, the memories (device memory 114, merchant memory 174, supplier memory 164) of the mobile device 110, merchant server 171, and payment system operator server 161 can store programming code executable by their respective processors (device processor 113, merchant processor 172, supplier processor 162) to carry out the mobile device payment methods.

The memories (device memory 114, merchant memory 174, supplier memory 164) of the mobile device 110, merchant server 171, and payment system operator server 161 can also store data.

Those skilled in the art will appreciate that the communication architecture for the mobile device payment system 100 is an example and that any number of other communication configurations can be used to carry out the method for a mobile device user to purchase goods/services from a merchant as described above.

FIGS. 2A & 2B are a block diagram of one embodiment of a mobile device payment method in accordance with the invention. In this embodiment, the mobile device user sets up a user account at a first bank and a merchant sets up a merchant account at a second bank. Credits and payments are transferred with cyberscrip through a distributed blockchain. The method 200 can be performed on the mobile device payment system describe in association with FIG. 1 above including the first bank, the second bank, and the distributed blockchain. Communications between components can be encrypted as desired for a particular application, e.g., using public and private keys in public-key cryptography.

Referring to FIG. 2A, the method 200 for a mobile device user to purchase goods/services from a merchant with a mobile device can include the following to prepare the mobile device payment system for use by the mobile device user: providing a mobile device 202, the mobile device having a device identifier permanently embedded in the mobile device; receiving a user account request 204 for a user account at a first bank, the user account request including a device name associated with the device identifier; establishing the user account 206 at the first bank, the user account associating the mobile device user with the device name; receiving a merchant account request 208 for a merchant account at a second bank, the merchant account request including a merchant name; establishing the merchant account 210 at the second bank, the merchant account associating the merchant with the merchant name; receiving a credit request 212 from the mobile device user at the first bank, the credit request including a requested credit amount in a government backed currency and the device name; converting the requested credit amount to a credit equivalent amount 214 in cyberscrip at the first bank; broadcasting a credit transaction message 216 to a blockchain network to register transfer in a distributed blockchain of the credit equivalent amount from the first bank to the user account of the mobile device user, the credit transaction message including a first bank parent blockchain reference, the credit equivalent amount, and the device name. Arrow 217 is for clarification only and illustrates credit flowing from the first bank to the mobile device user, although not no material or information flows directly from the first bank 180 to the mobile device user 112: the transfer is effected by registration of the transfer in the distributed blockchain.

Referring to FIG. 2B, the mobile device user can proceed to purchase goods/services from the merchant as follows: identifying goods/services for purchase 218 from the merchant by the mobile device user on the mobile device; determining a total price 220 for the identified goods/services on the mobile device; acquiring the merchant name 222 for the merchant on the mobile device; actuating a purchase button 224 on the mobile device; converting the total price 226 to a purchase equivalent amount in the cyberscrip; and broadcasting a purchase transaction message 228 to the blockchain network to register transfer in the distributed blockchain of the purchase equivalent amount from the user account of the mobile device user to the second bank, the purchase transaction message including a user parent blockchain reference, the purchase equivalent amount, and the merchant name. The method 200 can further include converting the purchase equivalent amount to a purchase amount 230 in the government backed currency at the second bank and depositing the purchase amount 232 in the merchant account. Arrow 229 is for clarification only and illustrates credit flowing from the mobile device user to the second bank, although no material or information flows directly from the mobile device user 112 to the second bank 190: the transfer is effected by registration of the transfer in the distributed blockchain.

In one embodiment, the method 200 can apply public and private key pairs in public-key cryptography to provide verification and security. In one example, the device identifier is a device private key, the device name is a device public key, and the merchant name is a merchant public key. The user account request is digitally signed with the device private key; the merchant account request is digitally signed with a merchant private key; the credit request is digitally signed with the device private key; the credit transaction message is digitally signed with a first bank private key; and the purchase transaction message is digitally signed with the device private key.

The providing a mobile device 202; receiving a user account request 204; establishing the user account 206; receiving a merchant account request 208; and establishing the merchant account 210 prepares the mobile device payment system for use by the mobile device user. The receiving a credit request 212; converting the requested credit amount to a credit equivalent amount 214; and broadcasting a credit transaction message 216 sets up the mobile device with credit, so that the mobile device user can make a purchase using the mobile device. The identifying goods/services for purchase 218; determining a total price 220; acquiring the merchant name 222; actuating a purchase button 224; converting the total price 226; and broadcasting a purchase transaction message 228 allows the mobile device user to purchase particular goods/services and credit the merchant. The converting the purchase equivalent amount to a purchase amount 230 and depositing the purchase amount 232 pays the merchant for the particular goods/services.

The preparation of the mobile device payment system for use by the mobile device user 202, 204, 206, 208, 210 can include various embodiments. The provider providing a mobile device 202 can be the payment system operator 160, a mobile device manufacturer, mobile device supplier, mobile device distributor, mobile phone network provider, a third party, or the like.

The setup of the mobile device with credit 212, 214, 216 can also include various embodiments. The receiving a credit request 212 from the mobile device user at the first bank can include additional requests. In one embodiment, the credit request further includes a request for a line of credit for the mobile device user from the first bank. In another embodiment, the credit request further includes a request for a loan for the mobile device user from the first bank. The credit can be provided by the first bank itself or from a third party, such as a financing entity, at the request of the first bank in response to receiving the credit request 212

The credit request from the mobile device user includes a requested credit amount in a government backed currency and the device name. The method 200 continues with converting the requested credit amount to a credit equivalent amount 214 in cyberscrip at the first bank. Monetary transactions for providing credit from the first bank to the mobile device user and for paying for goods/services by the mobile device user to the second bank for purchases from the merchant are carried out in cyberscrip. Cyberscrip as defined herein is any digital or virtual currency that uses cryptography for security. In one embodiment, the cyberscrip is an in-house scrip issued by a private party, such as a bank, payment system operator, or the like. The in-house scrip can have a fixed exchange rate to a government backed currency (fiat currency), such as the dollar, yen, or the like, to provide confidence in the value of the in-house scrip and to provide ease of use when converting between the government backed currency and the in-house scrip. In one embodiment, the in-house scrip can be a service mark of the issuing private party. For example, in-house scrip issued by XYZ Corporation could be called XYZ CashCoins. In another embodiment, the cyberscrip is a publicly traded cryptocurrency, such as Bitcoin, Ethereum, or the like, for which the exchange rate to the government backed currency can float.

The broadcasting a credit transaction message 216 to a blockchain network registers transfer in a distributed blockchain of the credit equivalent amount from the first bank to the user account of the mobile device user. Typically, the transaction is registered almost immediately after broadcasting from a few seconds to a few minutes. The credit transaction message can include a first bank parent blockchain reference, the credit equivalent amount, and the device name. The bank parent blockchain reference indicates the source of the cyberscrip as the first bank, the credit equivalent amount indicates the credit amount, and the device name indicates the recipient as the mobile device user.

Once the credit transaction message is broadcast to the blockchain network, the distributed blockchain servers register the transaction in the distributed blockchain, adding the new transaction block to the previous blockchain. In one embodiment, the distributed blockchain servers can employ a Bitcoin-type proof-of-work function to validate the transaction and to determine who receives mining credit for adding the new transaction block to the distributed blockchain. In another embodiment, the distributed blockchain servers can employ a different blockchain consensus protocol to validate the transaction and to determine who as the next block to the distributed blockchain, such as proof of stake, activity, burn, capacity, elapsed time, or the like. In one embodiment, the blockchain network is a public network, i.e., the blockchain network is completely open and anyone can join and participate in the network. In another embodiment, the blockchain network is a private network such as a permission network, which places restrictions on who is allowed to participate in the network and in what sort of transactions they are allowed to participate.

In one embodiment, the broadcasting a credit transaction message 216 can also include sending the first bank parent blockchain reference to the mobile device, so that the mobile device user can track and confirm the credit transaction. In one embodiment, the broadcasting a credit transaction message 216 can also include adding the credit equivalent amount to a balance available stored in the mobile device.

The purchase of particular goods/services and payment of the merchant 218, 220, 224, 226, 228 can also include various embodiments. In one embodiment, the identifying goods/services for purchase 218 from the merchant by the mobile device user on the mobile device can include ringing up the identified goods/services for purchase on a cash register at a physical store of the selected merchant; and the determining a total price 220 for the identified goods/services on the mobile device can include calculating the total price for the rung up identified goods/services; and transferring the calculated total price to the mobile device.

The transferring the calculated total price can include optically scanning the calculated total price with the mobile device. In one example, the calculated total price is embedded in a QR code for optical scanning. In another example, the calculated total price is displayed in alphanumeric characters on paper, a graphics display, or any other visual display, and the optically scanning can further include optical character recognition of the alphanumeric characters. In one example, the transferring the calculated total price to the mobile device can include wirelessly transferring the calculated total price to the mobile device using Wi-Fi, Bluetooth, near-field communication, or the like.

The method 200 can be part of a self-checkout system at a merchant store. In one embodiment, the identifying goods/services for purchase 218 from the merchant by the mobile device user on the mobile device and the determining a total price 220 can be performed solely by the mobile device user without assistance from merchant personnel, e.g., the mobile device user can scan the goods/services for purchase by themselves at the point of sale with the scanning system determining the total price of goods/services scanned. In one example, the mobile device user scans individual items for purchase with the mobile device while shopping through the store of the merchant, the mobile device determines the total price, acquires the merchant name, and the mobile device user actuates the purchase button on the mobile device without assistance from merchant personnel, avoiding the need to go through a checkout line.

The acquiring the merchant name 222 for the merchant on the mobile device determines which merchant is to be paid for the goods/services. In one embodiment, the acquiring the merchant name 222 can include determining a merchant location with a GPS on the mobile device; and determining the merchant name from the determined merchant location. in one example, the determining the merchant includes sending the determined merchant location to one of the second bank and the merchant; determining the merchant name from an index of merchant names by location; and sending the determined merchant name to the mobile device. Those skilled in the art will appreciate that GPS or any other locating system can be used to determine the merchant location as desired for a particular application.

The actuating a purchase button 224 on the mobile device; converting the total price 226 to a purchase equivalent amount in the cyberscrip; and broadcasting a purchase transaction message 228 to the blockchain network to register transfer in the distributed blockchain of the purchase equivalent amount from the user account of the mobile device user to the second bank, the purchase transaction message including a user parent blockchain reference, the purchase equivalent amount, and the merchant name, completes the method 200 through payment into the merchant account at the second bank. In another embodiment, the identified goods/services for purchase and the determined total price can be denominated in the cyberscrip, and the converting the total price 226 can be omitted.

The broadcasting a purchase transaction message 228 to the blockchain network registers transfer in the distributed blockchain of the purchase equivalent amount from the user account of the mobile device user to the second bank. Typically, the transaction is registered almost immediately after broadcasting from a few seconds to a few minutes. The purchase transaction message can include a user parent blockchain reference, the purchase equivalent amount, and the merchant name. The user parent blockchain reference indicates the source of the cyberscrip as the mobile device user, the purchase equivalent amount indicates the purchase amount, and the merchant name indicates the recipient as the merchant by way of the second bank. Once the purchase transaction message is broadcast to the blockchain network, the distributed blockchain servers register the transaction in the distributed blockchain, adding the new transaction block to the previous blockchain. In one embodiment, the broadcasting a purchase transaction message 228 can also include deducting the purchase equivalent amount from a balance available stored in the mobile device.

The method 200 can continue with payment of the merchant in the government backed currency. The method 200 can further include converting the purchase equivalent amount to a purchase amount 230 in the government backed currency at the second bank and depositing the purchase amount 232 in the merchant account. Arrow 229 is for clarification only and illustrates credit flowing from the mobile device user to the second bank, although no material or information flows directly from the mobile device user 112 to the second bank 190: the transfer is effected by registration of the transfer in the distributed blockchain.

FIGS. 3A & 3B are a block diagram of another embodiment of a mobile device payment method in accordance with the invention. In this embodiment, the merchant account for the merchant is acquired on the mobile device at the time of purchase at the merchant location. The payment system operator coordinates the payment system. The method 300 can be performed on the mobile device payment system described in association with FIG. 1 above including the payment system operator. Communications between components can be encrypted as desired for a particular application, e.g., using public and private keys in public-key cryptography.

Referring to FIG. 3A, the method 300 for a mobile device user to purchase goods/services from a merchant in association with a payment system operator can include: providing a mobile device 302 to the mobile device user, the mobile device including a consumer account and a universal merchant account, the mobile device having a permanent identifier embedded in the mobile device; establishing a user account 304 for the mobile device user with the payment system operator, the user account associating the mobile device user with the permanent identifier; establishing a merchant account 306 for the merchant with the payment system operator, the merchant account including a merchant identifier and merchant bank deposit information for the merchant; requesting the payment system operator to load consumer credit 308 into the consumer account by providing a credit amount and the permanent identifier to the payment system operator; loading the credit amount 310 into the consumer account of the mobile device associated with the permanent identifier.

Referring to FIG. 3B, with the mobile device payment system established, the mobile device user can proceed to purchase goods/services from the merchant as follows: identifying goods/services for purchase 312 from the merchant by the mobile device user on the mobile device; determining a total price 314 for the identified goods/services on the mobile device; acquiring the merchant account 316 for the merchant on the mobile device; storing the merchant account 318 in the universal merchant account of the mobile device; actuating a purchase button 320 on the mobile device; retrieving merchant bank deposit instructions 322 for the merchant identifier from the universal merchant account in response to the actuating the purchase button; retrieving purchase credit 324 in an amount of the total price from the consumer account in response to the actuating the purchase button; and routing the retrieved credit 326 to the merchant in accordance with the retrieved merchant bank deposit instructions. The permanent identifier is a unique identifier for the mobile device and the merchant identifier is a unique identifier for the merchant. In one embodiment, the merchant is one of a number of merchants and the universal merchant account includes a merchant identifier and merchant bank deposit information for each of the merchants.

The providing a mobile device 302; establishing a user account 304; and establishing a merchant account 306 prepares the mobile device payment system for use by the mobile device user. The requesting the payment system operator to load consumer credit 308; and loading the credit amount 310 sets up the mobile device as a virtual credit/debit card with money loaded on the mobile device, so that the mobile device user can make a purchase using the mobile device. The identifying goods/services for purchase 312; determining a total price 314; acquiring the merchant account 316; storing the merchant account 318; actuating a purchase button 320; retrieving merchant bank deposit instructions 322; retrieving purchase credit 324; and routing the retrieved credit 326 to the merchant in accordance with the retrieved merchant bank deposit instructions allows the mobile device user to purchase particular goods/services and pay the merchant for the particular goods/services.

The preparation of the mobile device payment system for use 302, 304, 306, can include various embodiments. The provider providing a mobile device 302 can be the payment system operator 160, a mobile device manufacturer, mobile device supplier, mobile device distributor, mobile phone network provider, a third party, or the like. In one embodiment, the establishing a merchant account 306 can include randomly selecting an alphanumeric code as the merchant identifier.

The setting up of the mobile device as a virtual credit/debit card 308, 310 can also include various embodiments. The credit amount can be provided by the payment system operator itself or from a third party, such as a financing entity, at the request of the payment system operator in response to the mobile device user requesting the payment system operator to load consumer credit 308. In one embodiment, the loading the credit amount 310 into the consumer account includes loading the credit amount into the consumer account from a user cash account maintained with the payment system operator. In another embodiment, the loading the credit amount 310 into the consumer account includes loading the credit amount into the consumer account from a user revolving credit account maintained with the payment system operator. In one embodiment, the loading the credit amount 310 into the consumer account establishes a credit balance on the mobile device and the method 300 can further include reducing the credit balance in the consumer account by the amount of the total price in response to the retrieving credit. The method 300 can further include restoring the credit balance to an initial value by loading the amount of the total price into the consumer account from a user account maintained with the payment system operator, the user account being selected from a user cash account and a user revolving credit account.

The purchase of particular goods/services and payment of the merchant for the particular goods/services 312, 314, 316, 318, 320, 322, 324, 326 can also include various embodiments. In one embodiment, the identifying goods/services 312 for purchase from the merchant by the mobile device user on the mobile device can include ringing up the identified goods/services for purchase on a cash register at a physical store of the merchant; with the determining a total price 314 for the identified goods/services including calculating the total price for the rung up identified goods/services; and transferring the calculated total price to the mobile device. In one example, the mobile device user scans individual items for purchase with the mobile device while shopping through the store of the merchant, the mobile device determines the total price, acquires and stores the merchant account, and the mobile device user actuates the purchase button on the mobile device without assistance from merchant personnel, avoiding the need to go through a checkout line.

The transferring the calculated total price to the mobile device can include optically scanning the calculated total price with the mobile device. In one example, the calculated total price is embedded in a QR code. In another example, the calculated total price is displayed in alphanumeric characters and the optically scanning further includes optical character recognition of the alphanumeric characters. In another embodiment, the transferring the calculated total price to the mobile device can include wirelessly transferring the calculated total price to the mobile device.

In one embodiment, the acquiring the merchant account 316 includes determining a merchant location with a GPS on the mobile device; and determining the merchant account from the determined merchant location. Those skilled in the art will appreciate that GPS or any other locating system can be used to determine the merchant location as desired for a particular application.

In one embodiment, the storing the merchant account 318 includes storing the single merchant account on the mobile device for the present determined merchant location. The single merchant account can optionally be cleared from the mobile device after the purchase is completed. In another embodiment, the storing the merchant account 318 includes storing the presently acquired merchant account with previously acquired merchant accounts on the mobile device. In one example, the mobile device can store a predetermined number of merchant accounts, with the oldest previously acquired merchant account being deleted from the mobile device when a new merchant account is acquired. For example, a mobile device with a storage capacity for ten merchant accounts would clear the tenth oldest merchant account when the storage capacity is full and a new merchant account is acquired. Thus, the acquired merchant accounts would revolve through the mobile device storage. The predetermined number of merchant accounts can be any number as desired within a given mobile device memory capacity.

Those skilled in the art will appreciate that the method 300 can employ a distributed blockchain for credit transfers between parties as desired for a particular application. In one example, the loading the credit amount 310 can include broadcasting a credit transaction message to transfer credit from the payment system operator 160 to the mobile device user 112. In another example, the routing the retrieved credit 326 can include broadcasting a purchase transaction message to transfer credit from the mobile device user 112 to the merchant 170.

The method 300 can also clear transaction information from the mobile device after a purchase. In one example, the method 300 can also include clearing temporary storage registers on the mobile device in response to the routing the retrieved credit 326 to the selected merchant. In one example, the method 300 can also include removing the stored merchant account from the universal merchant account of the mobile device after the purchase.

The method 300 can also account for shipping information. The user account can further associate the mobile device user with a shipping address. In one example, the method 300 also can include: sending an electronic order for the identified goods/services from the mobile device to the merchant in response to the actuating the purchase button, the electronic order including the permanent identifier and goods/services details for the identified goods/services, and no additional information about the mobile device user; sending a shipping address request including the permanent identifier from the mobile device to the payment system operator in response to the actuating the purchase button; and sending the shipping address from the payment system operator to the merchant in response to the sending a shipping address request. In another example, the method 300 also can include: sending an electronic order for the identified goods/services from the mobile device to the merchant in response to the actuating the purchase button, the electronic order including the permanent identifier and goods/services details for the identified goods/services, and no additional information about the mobile device user; receiving the electronic order at the merchant; sending a shipping address request including the permanent identifier from the merchant to the payment system operator in response to the receiving the electronic order button; and sending the shipping address from the payment system operator to the merchant in response to the sending a shipping address request. As used herein, “no additional information about the mobile device user” is defined as any information from which a third party could discern the identity of the mobile device user. In one embodiment, the mobile device can be selected from the group consisting of a smart phone and a digital tablet. The payment system operator can be a mobile device manufacturer, mobile device supplier, mobile device distributor, mobile phone network provider, a third party, or the like.

FIGS. 4A & 4B are a block diagram of another embodiment of a mobile device payment method in accordance with the invention. In this embodiment, the method 400 applies public and private keys in public-key cryptography to provide verification and security. Credits and payments are transferred with cyberscrip through distributed blockchain network. The payment system operator coordinates the payment system. The method 400 can be performed on the mobile device payment system describe in association with FIG. 1 above including the payment system operator and the distributed blockchain.

Referring to FIG. 4A, the method 400 for a mobile device user to purchase goods/services from a merchant in association with a payment system operator can include the following to prepare the mobile device payment system for use by the mobile device user: providing a mobile device 402 including a consumer account to the mobile device user, the mobile device having a device private key permanently embedded in the mobile device; receiving a user account request 404 for a user account at the payment system operator, the user account request being digitally signed with the device private key and including a device public key; establishing the user account 406, the user account associating the mobile device user with the device public key; receiving a merchant account request 408 for a merchant account at the payment system operator, the merchant account request being digitally signed with a merchant private key; establishing the merchant account 410, the merchant account associating the merchant with a merchant public key; sending merchant data 412 from the payment system operator to the mobile device user, the merchant data being digitally signed with an operator private key and including the merchant public key; receiving a cryptocurrency request 414 from the mobile device user at the payment system operator, the cryptocurrency request being digitally signed with the device private key, the cryptocurrency request including a requested credit amount and the device public key; sending a cryptocurrency response 416 including the requested credit amount to the mobile device user, the cryptocurrency response being digitally signed with the operator private key; broadcasting a credit transaction message 418 to a blockchain network to register transfer in a distributed blockchain of the requested credit amount from the payment system operator to the mobile device user, the credit transaction message being digitally signed with the operator private key, the credit transaction message including an operator blockchain reference, the requested credit amount, and the device public key.

Referring to FIG. 4B, the mobile device user can proceed to purchase goods/services from the merchant as follows: identifying goods/services for purchase 420 from the merchant by the mobile device user on the mobile device; determining a total price 422 for the identified goods/services and the merchant public key on the mobile device; actuating a purchase button 424 on the mobile device; and broadcasting a purchase transaction message 426 to the blockchain network in response to the actuating the purchase button to register transfer in the distributed blockchain of the total price from the mobile device user to the merchant, the purchase transaction message being digitally signed with the device private key, the credit transaction message including a device blockchain reference, the total price, and the merchant public key. In one embodiment, the merchant is one of a number of merchants and the merchant data includes a merchant public key for each of the number of merchants.

The providing a mobile device 402; receiving a user account request 404; establishing the user account 406; receiving a merchant account request 408; and establishing the merchant account 410 prepares the mobile device payment system for use by the mobile device user. The sending merchant data 412; receiving a cryptocurrency request 414; sending a cryptocurrency response 416; and broadcasting a credit transaction message to a blockchain network 418 sets up the mobile device with credit, so that the mobile device user can make a purchase using the mobile device. The identifying goods/services for purchase 420; determining a total price 422; actuating a purchase button 424; and broadcasting a purchase transaction message 426 allows the mobile device user to purchase particular goods/services and pay the merchant for the particular goods/services. Arrow 419 is for clarification only and illustrates payment flowing from the payment system operator 160 to the mobile device user 112 although no material or information flows directly from the payment system operator 160 to the mobile device user 112: the transfer is effected by registration of the transfer in the distributed blockchain.

The preparation of the mobile device payment system for use by the mobile device user 402, 404, 406, 408, 410 can include various embodiments. The provider providing a mobile device 402 can be the payment system operator 160, a mobile device manufacturer, mobile device supplier, mobile device distributor, mobile phone network provider, a third party, or the like.

The setup of the mobile device with credit 412, 414, 416, 418 can also include various embodiments. The receiving a cryptocurrency request 414 from the mobile device user at the payment system operator can include additional requests. In one embodiment, the cryptocurrency request further includes a request for a line of credit for the mobile device user from the payment system operator. In another embodiment, the cryptocurrency request further includes a request for a loan for the mobile device user from the payment system operator. The requested credit amount can be provided by the payment system operator itself or from a third party, such as a financing entity, at the request of the payment system operator in response to receiving the cryptocurrency request 414.

The cryptocurrency request from the mobile device user includes a requested credit amount and the device public key. The requested credit amount can be specified in government backed currency, cyberscrip, or any other denomination. Cyberscrip as defined herein is any digital or virtual currency that uses cryptography for security. In one embodiment, the cyberscrip is an in-house scrip issued by a private party, such as a bank, payment system operator, or the like. The in-house scrip can have a fixed exchange rate to a government backed currency (fiat currency), such as the dollar, yen, or the like, to provide confidence in the value of the in-house scrip and to provide ease of use when converting between the government backed currency and the in-house scrip. In one embodiment, the in-house scrip can be a service mark of the issuing private party. For example, in-house scrip issued by XYZ Corporation could be called XYZ CashCoins. In another embodiment, the cyberscrip is a publicly traded cryptocurrency, such as Bitcoin, Ethereum, or the like, for which the exchange rate to the government backed currency can float.

The broadcasting a credit transaction message 418 to a blockchain network registers transfer in a distributed blockchain of the requested credit amount from the payment system operator to the mobile device user. Typically, the transaction is registered almost immediately after broadcasting from a few seconds to a few minutes. The credit transaction message can include an operator blockchain reference, the requested credit amount, and the device public key. The operator blockchain reference indicates the source of the credit as the payment system operator, the requested credit amount indicates the credit amount being transferred, and the device public key indicates the recipient as the mobile device user by way of the mobile device.

Once the credit transaction message is broadcast to the blockchain network, the distributed blockchain servers register the transaction in the distributed blockchain, adding the new transaction block to the previous blockchain. In one embodiment, the distributed blockchain servers can employ a Bitcoin-type proof-of-work function to validate the transaction and to determine who receives mining credit for adding the new transaction block to the distributed blockchain. In another embodiment, the distributed blockchain servers can employ a different blockchain consensus protocol to validate the transaction and to determine who as the next block to the distributed blockchain, such as proof of stake, activity, burn, capacity, elapsed time, or the like. In one embodiment, the blockchain network is a public network, i.e., the blockchain network is completely open and anyone can join and participate in the network. In another embodiment, the blockchain network is a private network such as a permission network, which places restrictions on who is allowed to participate in the network and in what sort of transactions they are allowed to participate.

In one embodiment, the broadcasting a credit transaction message 418 can also include sending the operator blockchain reference to the mobile device, so that the mobile device user can track and confirm the credit transaction. In one embodiment, the broadcasting a credit transaction message 418 can also include adding the requested credit amount to a balance available stored in the mobile device.

The purchase of particular goods/services and payment of the merchant for the particular goods/services 420, 422, 424, 426 can also include various embodiments.

In one embodiment, the identifying goods/services for purchase 420 from the merchant by the mobile device user on the mobile device can include ringing up the identified goods/services for purchase on a cash register at a physical store of the merchant; and the determining a total price 422 for the identified goods/services on the mobile device can include calculating the total price for the rung up identified goods/services; and transferring the calculated total price to the mobile device. The transferring the calculated total price can include optically scanning the calculated total price with the mobile device. In one example, the calculated total price is embedded in a QR code for optical scanning. In another example, the calculated total price is displayed in alphanumeric characters on paper, a graphics display, or any other visual display, and the optically scanning can further include optical character recognition of the alphanumeric characters. In one example, the transferring the calculated total price to the mobile device can include wirelessly transferring the calculated total price to the mobile device using Wi-Fi, Bluetooth, near-field communication, or the like.

The method 400 can be part of a self-checkout system at a merchant store. In one embodiment, the identifying goods/services for purchase 420 from the merchant by the mobile device user on the mobile device and the determining a total price 422 can be performed solely by the mobile device user without assistance from merchant personnel, e.g., the mobile device user can scan the goods/services for purchase by themselves at the point of sale with the scanning system determining the total price of goods/services scanned. In one example, the mobile device user scans individual items for purchase with the mobile device while shopping through the store of the merchant, the mobile device determines the total price and the merchant public key, and the mobile device user actuates the purchase button on the mobile device without assistance from merchant personnel, avoiding the need to go through a checkout line.

The determining a total price for the identified goods/services and the merchant public key 422 on the mobile device can further include determining a merchant location with a GPS on the mobile device; and determining the merchant public key from the determined merchant location. Those skilled in the art will appreciate that GPS or any other locating system can be used to determine the merchant public key as desired for a particular application.

The broadcasting a purchase transaction message 426 to the blockchain network in response to the actuating the purchase button 424 registers transfer in the distributed blockchain of the total price from the mobile device user to the merchant. Typically, the transaction is registered almost immediately after broadcasting from a few seconds to a few minutes. The purchase transaction message can include a device blockchain reference, the total price, and the merchant public key. The device blockchain reference indicates the payment source as the mobile device user, the total price indicates the purchase amount, and the merchant public key indicates the payment recipient as the merchant. Once the purchase transaction message is broadcast to the blockchain network, the distributed blockchain servers register the transaction in the distributed blockchain, adding the new transaction block to the previous blockchain. In one embodiment, the broadcasting a purchase transaction message 426 can also include deducting the total price from a balance available stored in the mobile device. Arrow 427 is for clarification only and illustrates payment flowing from the mobile device user to the merchant, although no material or information flows directly from the mobile device user 112 to the merchant 170: the transfer is effected by registration of the transfer in the distributed blockchain.

Those skilled in the art will appreciate that the elements of the methods described in association with FIGS. 2-4 can be stored as computer readable code on a non-transitory computer readable medium as desired for a particular application. As defined herein, “non-transitory computer readable medium” comprises all computer readable medium, with the sole exception being a transitory, propagating signal. The non-transitory computer readable medium can include volatile and/or non-volatile memory. Volatile memory can include memory that depends upon power to store information, e.g., various types of dynamic random access memory (DRAM), and the like. Non-volatile memory can include memory that does not depend upon power to store information, e.g., solid state media such as flash memory, EEPROM, phase change random access memory (PCRAM), and the like. Other exemplary non-transitory computer readable medium include optical discs such as digital video discs (DVD), high definition digital versatile discs (HD DVD), compact discs (CD), and laser discs; magnetic media such as magnetic tapes, tape drives, floppy discs, and magnetic hard drives; solid state media such as flash memory, memory cards, solid-state drives, USB flash drives, random access memory (RAM), static random access memory (SRAM), dynamic random access memory (DRAM), magnetic random access memory (MRAM), phase change random access memory (PCRAM), read-only memory (ROM), programmable read-only memory (PROM), erasable programmable read-only memory (EPROM), electrically erasable programmable read-only memory (EEPROM); and other types of media from which a computer, a processor or other electronic device can read.

Those skilled in the art will further appreciate that the elements of the methods described in association with FIGS. 2-4 can be expressed as signals between components of the mobile device payment system when information is transferred between the components as desired for a particular application. Those skilled in the art will appreciate that programming code for a step of the method initiated in one component can require complementary programming code for a step of the method completed in another component.

It is important to note that FIGS. 1-4 illustrate specific applications and embodiments of the invention, and are not intended to limit the scope of the present disclosure or claims to that which is presented therein. For example, other entities, such as a mobile device manufacturer, mobile device supplier, mobile device distributor, a third party, or the like, can take the place of the payment system operator. Upon reading the specification and reviewing the drawings hereof, it will become immediately obvious to those skilled in the art that myriad other embodiments of the invention are possible, and that such embodiments are contemplated and fall within the scope of the presently claimed invention.

Those skilled in the art will appreciate that the elements of the methods described in association with FIGS. 2-4 can be beneficially combined as desired for a particular application.

In one exemplary combination, the two bank embodiment described in conjunction with FIG. 2 can be applied to the embodiments as described in conjunction with FIG. 3 or FIG. 4.

For the FIG. 3 embodiment, the payment system operator 160 can be replaced by the first bank 180 and the second bank 190. The first bank 180 can be responsible for communication with the mobile device user 112 while the second bank 190 can be responsible for communication with the merchant 170. When acquiring the merchant account 316 for the merchant on the mobile device, the merchant account can have previously been supplied to the first bank 184 for access by the mobile device user 112 by the second bank 190, the merchant 170, or a third party. In another example, when acquiring the merchant account 316 for the merchant on the mobile device, the mobile device user 112 can acquire the merchant account directly from the second bank 190, the merchant 170, or a third party, rather than acquiring the merchant account through the first bank 184.

For the FIG. 4 embodiment, the payment system operator 160 can be replaced by the first bank 180 and the second bank 190. The first bank 180 can be responsible for communication with the mobile device user 112 while the second bank 190 can be responsible for communication with the merchant 170. When sending merchant data 412, the merchant data can be sent from the first bank 184, which could have previously been supplied to the first bank 184 for access by the mobile device user 112 by the second bank 190, the merchant 170, or a third party. In another example, when sending merchant data 412, the merchant data can be sent directly to the mobile device user 112 from the second bank 190, the merchant 170, or a third party, rather than acquiring the merchant account through the first bank 184.

In another exemplary combination, the embodiment described in conjunction with FIG. 2 regarding acquisition of the merchant account for the merchant on the mobile device at the time of purchase at the merchant location can be applied to the embodiments as described in conjunction with FIG. 2 or FIG. 4.

For the FIG. 2 embodiment, the acquiring the merchant name 222 for the merchant on the mobile device can include acquiring the merchant name from any party having the merchant name, such as the first bank 180, the second bank 190, the merchant 170, or a third party, at the time of purchase at the merchant location at any time prior to the actuating the purchase button 224. For the FIG. 4 embodiment, the sending merchant data 412 can be from the payment system operator 160, the merchant 170, or a third party at the point of sale prior to the actuating the purchase button 424, rather than being limited to the payment system operator 160, at the time of purchase at the merchant location at any time prior to the actuating the purchase button 424.

In another exemplary combination, the embodiment described in conjunction with FIG. 4 regarding application of public and private keys in public-key cryptography can be applied to the embodiments as described in conjunction with FIG. 2 or FIG. 3.

For the FIG. 2 embodiment, the mobile device, first bank 180, second bank 190, and/or merchant 170 can be associated with public and private keys in public-key cryptography. Messages from a party and be can be signed and encrypted with the private key of the party and verified and decrypted by the recipient with the public key of the sending party. For the FIG. 3 embodiment, the mobile device, payment system operator 160, and/or merchant 170 can be associated with public and private keys in public-key cryptography. Messages from a party and be can be signed and encrypted with the private key of the party and verified and decrypted by the recipient with the public key of the sending party.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method for a mobile device user to purchase goods/services from a merchant with a mobile device, the method comprising:
providing a mobile device, the mobile device having a device identifier permanently embedded in the mobile device;
receiving a user account request for a user account at a first bank, the user account request including a device name associated with the device identifier;
establishing the user account at the first bank, the user account associating the mobile device user with the device name;
receiving a merchant account request for a merchant account at a second bank, the merchant account request including a merchant name;
establishing the merchant account at the second bank, the merchant account associating the merchant with the merchant name;
receiving a credit request from the mobile device user at the first bank, the credit request including a requested credit amount in a government backed currency and the device name;
converting the requested credit amount to a credit equivalent amount in cyberscrip at the first bank;
broadcasting a credit transaction message to a blockchain network to register transfer in a distributed blockchain of the credit equivalent amount from the first bank to the user account of the mobile device user, the credit transaction message including a first bank parent blockchain reference, the credit equivalent amount, and the device name;
identifying goods/services for purchase from the merchant by the mobile device user on the mobile device;
determining a total price for the identified goods/services on the mobile device;
acquiring the merchant name for the merchant on the mobile device;
actuating a purchase button on the mobile device;
converting the total price to a purchase equivalent amount in the cyberscrip; and
broadcasting a purchase transaction message to the blockchain network to register transfer in the distributed blockchain of the purchase equivalent amount from the user account of the mobile device user to the second bank, the purchase transaction message including a user parent blockchain reference, the purchase equivalent amount, and the merchant name.

2. The method of claim 1 further comprising converting the purchase equivalent amount to a purchase amount in the government backed currency at the second bank and depositing the purchase amount in the merchant account.

3. The method of claim 1 wherein:
the device identifier is a device private key;
the device name is a device public key paired with the device private key;
the merchant name is a merchant public key;
the user account request is digitally signed with the device private key;
the merchant account request is digitally signed with a merchant private key paired with the merchant public key;
the credit request is digitally signed with the device private key;
the credit transaction message is digitally signed with a first bank private key; and
the purchase transaction message is digitally signed with the device private key.

4. The method of claim 1 wherein the credit request further comprises a request for a line of credit for the mobile device user from the first bank.

5. The method of claim 1 wherein the credit request further comprises a request for a loan for the mobile device user from the first bank.

6. The method of claim 1 wherein the cyberscrip is an in-house scrip.

7. The method of claim 1 wherein the cyberscrip is a publicly traded cryptocurrency.

8. The method of claim 1 wherein the blockchain network is a public network.

9. The method of claim 1 wherein the blockchain network is a private network.

10. The method of claim 1 wherein the broadcasting the credit transaction message further comprises sending the first bank parent blockchain reference to the mobile device.

11. The method of claim 1 wherein the broadcasting the credit transaction message further comprises adding the credit equivalent amount to a balance available stored in the mobile device.

12. The method of claim 1 wherein:
the identifying goods/services for purchase from the merchant by the mobile device user on the mobile device comprises ringing up the identified goods/services for purchase on a cash register at a physical store of the selected merchant; and
the determining a total price for the identified goods/services on the mobile device comprises:
calculating the total price for the rung up identified goods/services; and
transferring the calculated total price to the mobile device.

13. The method of claim 12 wherein the transferring the calculated total price to the mobile device comprises optically scanning the calculated total price with the mobile device.

14. The method of claim 13 wherein the calculated total price is embedded in a QR code.

15. The method of claim 13 wherein the calculated total price is displayed in alphanumeric characters and the optically scanning further comprises optical character recognition of the alphanumeric characters.

16. The method of claim 12 wherein the transferring the calculated total price to the mobile device comprises wirelessly transferring the calculated total price to the mobile device.

17. The method of claim 1 wherein the acquiring the merchant name comprises:
determining a merchant location with a GPS on the mobile device; and
determining the merchant name from the determined merchant location.

18. The method of claim 17 wherein the determining the merchant name comprises:
sending the determined merchant location to one of the second bank and the merchant;
determining the merchant name from an index of merchant names by location; and
sending the determined merchant name to the mobile device.

19. A method for a mobile device user to purchase goods/services from a merchant in association with a payment system operator, the method comprising:
providing a mobile device to the mobile device user, the mobile device including a consumer account and a universal merchant account, the mobile device having a permanent identifier embedded in the mobile device;
establishing a user account for the mobile device user with the payment system operator, the user account associating the mobile device user with the permanent identifier;
establishing a merchant account for the merchant with the payment system operator, the merchant account including a merchant identifier and merchant bank deposit information for the merchant;
requesting the payment system operator to load consumer credit into the consumer account by providing a credit amount and the permanent identifier to the payment system operator;
loading the credit amount into the consumer account of the mobile device associated with the permanent identifier;
identifying goods/services for purchase from the merchant by the mobile device user on the mobile device;
determining a total price for the identified goods/services on the mobile device;
acquiring the merchant account for the merchant on the mobile device;
storing the merchant account in the universal merchant account of the mobile device;
actuating a purchase button on the mobile device;
retrieving merchant bank deposit instructions for the merchant identifier from the universal merchant account in response to the actuating the purchase button;
retrieving purchase credit in an amount of the total price from the consumer account in response to the actuating the purchase button; and
routing the retrieved credit to the merchant in accordance with the retrieved merchant bank deposit instructions.

20. The method of claim 19 wherein the merchant is one of a plurality of merchants and the universal merchant account includes a merchant identifier and merchant bank deposit information for each of the plurality of merchants.

21. The method of claim 19 wherein the user account further associates the mobile device user with a shipping address, the method further comprising:
sending an electronic order for the identified goods/services from the mobile device to the merchant in response to the actuating the purchase button, the electronic order including the permanent identifier and goods/services details for the identified goods/services, and no additional information about the mobile device user;
sending a shipping address request including the permanent identifier from the mobile device to the payment system operator in response to the actuating the purchase button; and
sending the shipping address from the payment system operator to the merchant in response to the sending a shipping address request.

22. The method of claim 19 wherein the user account further associates the mobile device user with a shipping address, the method further comprising:
sending an electronic order for the identified goods/services from the mobile device to the merchant in response to the actuating the purchase button, the electronic order including the permanent identifier and goods/services details for the identified goods/services, and no additional information about the mobile device user;
receiving the electronic order at the merchant;
sending a shipping address request including the permanent identifier from the merchant to the payment system operator in response to the receiving the electronic order button; and
sending the shipping address from the payment system operator to the merchant in response to the sending a shipping address request.

23. The method of claim 19 wherein:
the identifying goods/services for purchase from the merchant by the mobile device user on the mobile device comprises ringing up the identified goods/services for purchase on a cash register at a physical store of the merchant; and
the determining a total price for the identified goods/services comprises:
calculating the total price for the rung up identified goods/services; and
transferring the calculated total price to the mobile device.

24. The method of claim 23 wherein the transferring the calculated total price to the mobile device comprises optically scanning the calculated total price with the mobile device.

25. The method of claim 24 wherein the calculated total price is embedded in a QR code.

26. The method of claim 24 wherein the calculated total price is displayed in alphanumeric characters and the optically scanning further comprises optical character recognition of the alphanumeric characters.

27. The method of claim 23 wherein the transferring the calculated total price to the mobile device comprises wirelessly transferring the calculated total price to the mobile device.

28. The method of claim 19 wherein the acquiring the merchant account comprises:
determining a merchant location with a GPS on the mobile device; and
determining the merchant account from the determined merchant location.

29. The method of claim 19 wherein the establishing a merchant account for the merchant with the payment system operator further comprises randomly selecting an alphanumeric code as the merchant identifier.

30. The method of claim 19 wherein the loading the credit amount into the consumer account comprises loading the credit amount into the consumer account from a user cash account maintained with the payment system operator.

31. The method of claim 19 wherein the loading the credit amount into the consumer account comprises loading the credit amount into the consumer account from a user revolving credit account maintained with the payment system operator.

32. The method of claim 19 wherein the loading the credit amount into the consumer account establishes a credit balance on the mobile device, the method further comprising reducing the credit balance in the consumer account by the amount of the total price in response to the retrieving credit.

33. The method of claim 32 further comprising restoring the credit balance to an initial value by loading the amount of the total price into the consumer account from a user account maintained with the payment system operator, the user account being selected from the group consisting of a user cash account and a user revolving credit account.

34. The method of claim 19 further comprising clearing temporary storage registers on the mobile device in response to the routing of the retrieved credit to the merchant.

35. A method for a mobile device user to purchase goods/services from a merchant in association with a payment system operator, the method comprising:
providing a mobile device including a consumer account to the mobile device user, the mobile device having a device private key permanently embedded in the mobile device;
receiving a user account request for a user account at the payment system operator, the user account request being digitally signed with the device private key and including a device public key, the user account associating the mobile device user with the device public key;
establishing the user account, the user account associating the mobile device user with the device public key;
receiving a merchant account request for a merchant account at the payment system operator, the merchant account request being digitally signed with a merchant private key;
establishing the merchant account, the merchant account associating the merchant with a merchant public key;
sending merchant data from the payment system operator to the mobile device user, the merchant data being digitally signed with an operator private key and including the merchant public key;
receiving a cryptocurrency request from the mobile device user at the payment system operator, the cryptocurrency request being digitally signed with the device private key, the cryptocurrency request including a requested credit amount and the device public key;
sending a cryptocurrency response including the requested credit amount to the mobile device user, the cryptocurrency response being digitally signed with the operator private key;
broadcasting a credit transaction message to a blockchain network to register transfer in a distributed blockchain of the requested credit amount from the payment system operator to the mobile device user, the credit transaction message being digitally signed with the operator private key, the credit transaction message including an operator blockchain reference, the requested credit amount, and the device public key;
identifying goods/services for purchase from the merchant by the mobile device user on the mobile device;
determining a total price for the identified goods/services and the merchant public key on the mobile device;
actuating a purchase button on the mobile device; and
broadcasting a purchase transaction message to the blockchain network in response to the actuating the purchase button to register transfer in the distributed blockchain of the total price from the mobile device user to the merchant, the purchase transaction message being digitally signed with the device private key, the credit transaction message including a device blockchain reference, the total price, and the merchant public key.

36. The method of claim 35 wherein the merchant is one of a plurality of merchants and the merchant data includes a merchant public key for each of the plurality of merchants.

37. The method of claim 35 wherein the cryptocurrency request further comprises a request for a line of credit for the mobile device user from the payment system operator.

38. The method of claim 35 wherein the cryptocurrency request further comprises a request for a loan for the mobile device user from the payment system operator.

39. The method of claim 35 wherein the blockchain network is a public network.

40. The method of claim 35 wherein the blockchain network is a private network.

41. The method of claim 35 wherein the broadcasting the credit transaction message further comprises sending the operator blockchain reference to the mobile device.

42. The method of claim 35 wherein the broadcasting the credit transaction message further comprises adding the requested credit amount to a balance available stored in the mobile device.

43. The method of claim 35 wherein:
the identifying goods/services for purchase from the merchant by the mobile device user on the mobile device comprises ringing up the identified goods/services for purchase on a cash register at a physical store of the merchant; and
the determining a total price for the identified goods/services on the mobile device comprises:
calculating the total price for the rung up identified goods/services; and
transferring the calculated total price to the mobile device.

44. The method of claim 43 wherein the transferring the calculated total price to the mobile device comprises optically scanning the calculated total price with the mobile device.

45. The method of claim 44 wherein the calculated total price is embedded in a QR code.

46. The method of claim 44 wherein the calculated total price is displayed in alphanumeric characters and the optically scanning further comprises optical character recognition of the alphanumeric characters.

47. The method of claim 43 wherein the transferring the calculated total price to the mobile device comprises wirelessly transferring the calculated total price to the mobile device.

48. The method of claim 35 wherein the determining a total price for the identified goods/services and the merchant public key on the mobile device further comprises:
determining a merchant location with a GPS on the mobile device; and
determining the merchant public key from the determined merchant location.

49. The method of claim 35 wherein the broadcasting the purchase transaction message further comprises deducting the total price from a balance available stored in the mobile device.
